(19) United States
(12) Patent Application Publication
(10) Pub. No.: US 2020/0256735 A1
(43) Pub. Date: Aug. 13, 2020

(54) Systems and Methods for Monitoring Temperature of a Luminaire Optics

(71) Applicant: Eaton Intelligent Power Limited, Dublin 4 (IE)

(72) Inventors: Walten Peter Owens, Chittenango, NY (US); Khurram Moghal, Senoia, GA (US); Benjamin David Vollmer, Manlius, NY (US)

(21) Appl. No.: 16/787,168

(22) Filed: Feb. 11, 2020

Related U.S. Application Data
(60) Provisional application No. 62/803,742, filed on Feb. 11, 2019.

(51) Int. Cl. G01J 5/02; F21V 29/70; G01K 1/08

(52) U.S. Cl. CPC G01J 5/02; F21Y 2115/10; G01K 1/08; F21V 29/70

(57) ABSTRACT

A lighting module for an illumination device includes at least one light source mounted on a substrate and an optical assembly positioned to be located over the at least one light source. The lighting module also includes a temperature sensor configured to collect temperature data corresponding to the optical assembly.

### CROSS REFERENCE TO RELATED APPLICATIONS

This application claims priority to U.S. Provisional Application No. 62/803,742, filed Feb. 11, 2019, the disclosure of which is incorporated herein by reference in its entirety.

### BACKGROUND

The advent of light emitting diode (LED) based luminaires has provided sports arenas, stadiums, other entertainment facilities, and other commercial and industrial facilities the ability to achieve instant on-off capabilities, intelligent controls and adjustability while delivering excellent light quality, consistent light output, and improved energy efficiency. Because of this, users continue to seek improvements in LED lighting devices. Monitoring the inside temperature of a luminaire is important to prevent overheating, breakdown, or shortening of the operational lifespan.

In traditional luminaires, a temperature sensor is configured to detect temperature changes corresponding to the LEDs of the luminaire and not the optical elements. This often leads to breakdown or degradation of the optical elements because the LED typically have a higher temperature tolerance compared to optical elements. Furthermore, while typical LED lighting devices include a heat sink to remove heat generated by the LEDs, the heat sink is not configured to take into consideration operational temperature ranges of the optical elements. In addition, accumulation of dirt and debris on the luminaire may lead to undesirable increase in the inside temperature of the luminaire which cannot be removed by the heat sink effectively.

This document describes a lighting fixture and methods of manufacturing thereof that are directed to solving the issues described above, and/or other problems.

### SUMMARY

In one or more scenarios, a lighting module for an illumination device that includes a temperature sensor is described. The lighting module may include at least one light source mounted on a substrate and an optical assembly positioned to be located over the at least one light source. The temperature sensor may be configured to collect temperature data corresponding to the optical assembly.

Optionally, the temperature sensor may be a non-contact type infrared (IR) sensor. A temperature sensor may be mounted on the substrate.

In certain scenarios, the lighting module may also include a processor and a non-transitory computer-readable medium comprising programming instructions. The processor may be configured to receive temperature data corresponding to the optical assembly from the temperature sensor, analyze the received temperature data to determine if temperature of the optical assembly is greater than a threshold temperature, and in response to determining that the temperature of the optical assembly is greater than a threshold temperature, perform a preventive action.

In certain embodiments, the preventive action may include providing an alert to a user. The alert may include, for example, instructions to initiate a cooling action, instructions to control power delivered to the at least one light source, information relating to potential damage to one or more components of the lighting module due to overheating, or combinations thereof.

Additionally and/or alternatively, the preventive action may include automatically controlling power delivered to the at least one light source. Optionally, controlling the power delivered to the at least one light source may include reducing power delivered to the at least one light source while maintaining a constant illumination output by the lighting module.

In one or more embodiments, the processor may also analyze the received information to determine a rate of change of temperature of the optical assembly, analyze the rate of change of temperature to determine whether the lighting module includes a fault condition, and provide an alert to a user that includes information about the fault condition. Optionally, the fault condition may include accumulation of debris on the optical assembly that leads to overheating of the optical assembly.

The threshold level may be determined based one, for example, a type of the at least one light source, a material of the optical assembly, a material of other components of the lighting module, one or more ambient conditions, a type of use of the lighting module, efficiency of a heat sink associated with the lighting module, or combinations thereof. Optionally, the threshold level may be less than a first upper limit associated with an operational temperature range of the optical assembly, the first upper limit being less than a second upper limit associated with an operational temperature range of the at least one light source.

In some scenarios, a temperature sensor for sensing real-time temperature of an optical assembly of a lighting device comprising at least one light source situated under the optical assembly is disclosed. Such a temperature sensor may include an infrared (IR) sensor having a field of view that includes the optical assembly when the temperature sensor is included inside the lighting device.

In one or more embodiments, the temperature sensor also comprises a processor that is configured to analyze blackbody radiation emitted by the optical assembly to determine a temperature of the optical assembly. A processor (of the temperature sensor or an external processor) may analyze the temperature data to determine if temperature of the optical assembly is greater than a threshold temperature, and in response to determining that the temperature of the optical assembly is greater than a threshold temperature, perform a preventive action.

In certain embodiments, the preventive action may include providing an alert to a user. The alert may include, for example, instructions to initiate a cooling action, instructions to control power delivered to the at least one light source, information relating to potential damage to one or more components of the lighting module due to overheating, or combinations thereof.

Additionally and/or alternatively, the preventive action may include automatically controlling power delivered to the at least one light source. Optionally, controlling the power delivered to the at least one light source may include reducing power delivered to the at least one light source while maintaining a constant illumination output by the lighting module.

In one or more embodiments, the processor may also analyze the received information to determine a rate of change of temperature of the optical assembly, analyze the rate of change of temperature to determine whether the lighting module includes a fault condition, and provide an alert to a user that includes information about the fault condition. Optionally, the fault condition may include accumulation of debris on the optical assembly that leads to overheating of the optical assembly.

The threshold level may be determined based one, for example, a type of the at least one light source, a material of the optical assembly, a material of other components of the lighting module, one or more ambient conditions, a type of use of the lighting module, efficiency of a heat sink associated with the lighting module, or combinations thereof. Optionally, the threshold level may be less than a first upper limit associated with an operational temperature range of the optical assembly, the first upper limit being less than a second upper limit associated with an operational temperature range of the at least one light source.

### BRIEF DESCRIPTION OF THE DRAWINGS

FIG. 1 illustrates a perspective view of an example lighting device, according to an embodiment.

FIG. 2 is a cross-sectional view of a lighting module of an example lighting device, according to an embodiment.

FIG. 3 illustrates an example position of a temperature sensor for monitoring the temperature of an optical element, according to an embodiment.

FIG. 4 is a flowchart illustrating an example method for controlling the power supplied to a lighting module based on temperature data, according to an embodiment.

FIG. 5 depicts an example of internal hardware that may be used to contain or implement the various processes and systems as described in this disclosure.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.”

When used in this document, terms such as “top” and “bottom,” “upper” and “lower”, or “front” and “rear,” are not intended to have absolute orientations but are instead intended to describe relative positions of various components with respect to each other. For example, a first component may be an “upper” component and a second component may be a “lower” component when a light fixture is oriented in a first direction. The relative orientations of the components may be reversed, or the components may be on the same plane, if the orientation of a light fixture that contains the components is changed. The claims are intended to include all orientations of a device containing such components.

In this document, the terms “lighting device,” “light fixture,” “luminaire” and “illumination device” are used interchangeably to refer to a device that includes a source of optical radiation. Sources of optical radiation may include, for example, light emitting diodes (LEDs), light bulbs, ultraviolet light or infrared sources, or other sources of optical radiation. In the embodiments disclosed in this document, the optical radiation emitted by the lighting devices includes visible light. A lighting device will also include a housing, one or more electrical components for conveying power from a power supply to the device's optical radiation source, and optionally control circuitry.

In this document, the terms “controller” and “controller device” mean an electronic device or system of devices containing a processor and configured to command or otherwise manage the operation of one or more other devices. A controller will typically include a processing device, and it will also include or have access to a memory device that contains programming instructions configured to cause the controller's processor to manage operation of the connected device or devices.

In this document, the terms “memory” and “memory device” each refer to a non-transitory device on which computer-readable data, programming instructions or both are stored. Except where specifically stated otherwise, the terms “memory” and “memory device” are intended to include single-device embodiments, embodiments in which multiple memory devices together or collectively store a set of data or instructions, as well as one or more individual sectors within such devices.

In this document, the terms “processor”, “processing device”, “processing circuit” refer to a hardware component of an electronic device (such as a controller) that is configured to execute programming instructions. Except where specifically stated otherwise, the singular term “processor” or “processing device” is intended to include both single processing device embodiments and embodiments in which multiple processing devices together or collectively perform a process.

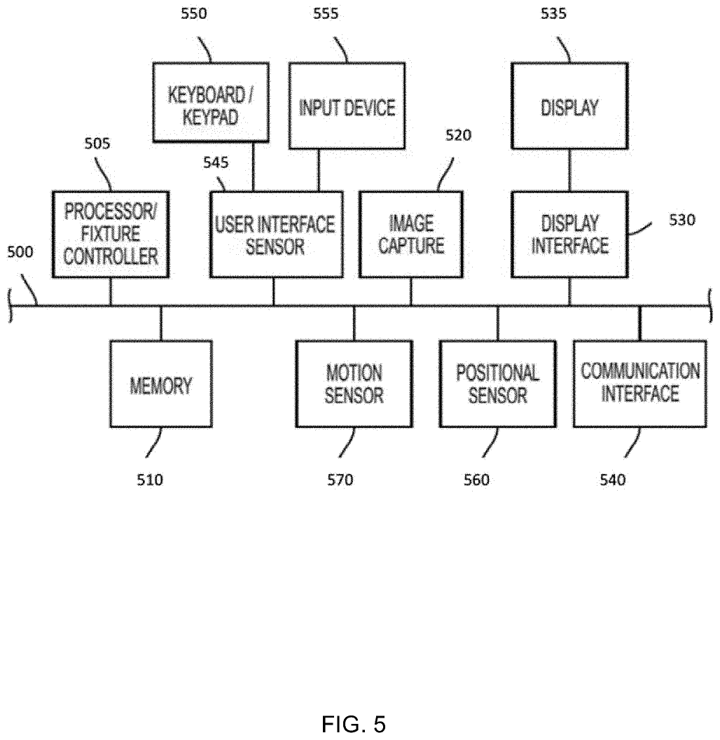

An “electronic device” refers to an electronic device having a processor, a memory device, and a communication interface for communicating with proximate and/or local devices. The memory will contain or receive programming instructions that, when executed by the processor, will cause the electronic device to perform one or more operations according to the programming instructions. Examples of electronic devices include personal computers, servers, mainframes, virtual machines, containers, gaming systems, televisions, and portable electronic devices such as smartphones, wearable virtual reality devices, Internet-connected wearables such as smart watches and smart eyewear, personal digital assistants, tablet computers, laptop computers, media players and the like. Electronic devices also may include appliances and other devices that can communicate in an Internet-of-things arrangement, such as smart thermostats, home controller devices, voice-activated digital home assistants, connected light bulbs and other devices. In a client-server arrangement, the client device and the server are electronic devices, in which the server contains instructions and/or data that the client device accesses via one or more communications links in one or more communications networks. In a virtual machine arrangement, a server may be an electronic device, and each virtual machine or container may also be considered to be an electronic device. In the discussion below, a client device, server device, virtual machine or container may be referred to simply as a “device” for brevity. Additional elements that may be included in electronic devices will be discussed below in the context of FIG. 5.

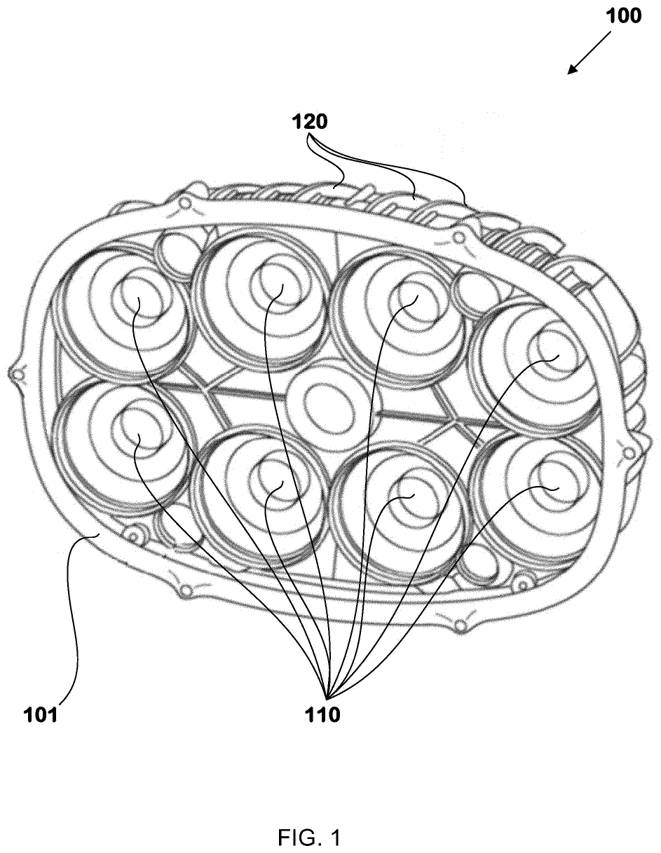

FIG. 1 illustrates one embodiment of an example lighting device 100 that configured to monitor the internal temperature of one or more of its components. As shown in FIG. 1, the lighting device 100 includes a housing 101 that encases various components of a light fixture. The housing 101 includes an opening in which an optical radiation source, such as any number of lighting modules 110 that include LEDs are included. Any number of lighting modules 110, such as one, two, three, four, five or more, sufficient to provide a high intensity LED device, may be positioned within the opening in any configuration. In various embodiments, a lighting device may include multiple types of lighting modules. For example, a lighting device may include a first type of lighting module having LEDs that are configured to selectably emit white light of various color temperatures, along with a second type of lighting module having LEDs that are configured to selectably emit light of various colors. The lighting modules 110 may include an optional optical arrangement (interchangeably, “optics” or “optical assembly”) comprising one or more optical elements, as will be described in more detail below.

While the lighting modules 110 are positioned at one side of the housing, the opposing side of the body may include or be connected to a power supply (not shown here). The power supply may include a battery, solar panel, or circuitry to receive power from an external and/or other internal source. The external housing of the power supply also may include fins to help dissipate heat from the power supply. Power wiring may be positioned within the body to direct power from the power supply to the LEDs.

The device's housing 101 may include an optional heat sink 120 for dissipating heat that is generated by one or more components (e.g., LEDs, power supply, etc.) of the lighting modules 110. The heat sink 120 may be formed of aluminum and/or other metal, plastic or other material, and it may include any number of fins on the exterior to increase its surface area that will contact a surrounding cooling medium (typically, air). Thus, heat from the lighting module components (e.g., LEDs) may be drawn away from the lighting modules 110 and dissipated via the fins of the heat sink 120.

The housing 101 also may holds electrical components such as a fixture controller and wiring and circuitry to supply power and/or control signals to the lighting modules 110. A fixture controller may be an external device or an integral device that includes various components of a lighting device's control circuitry (such as a processor and memory with programming instructions, an application-specific integrated circuit or a system-on-a-chip, a communications interface, etc.) configured to selectively control which LEDs in the lighting modules are to receive power, and to vary the power delivered to the LEDs by methods such as pulse width modulation (PWM). Optionally, the housing 101 may be attached to a support structure (not shown here), such as a base or mounting yoke, optionally by one or more connectors.

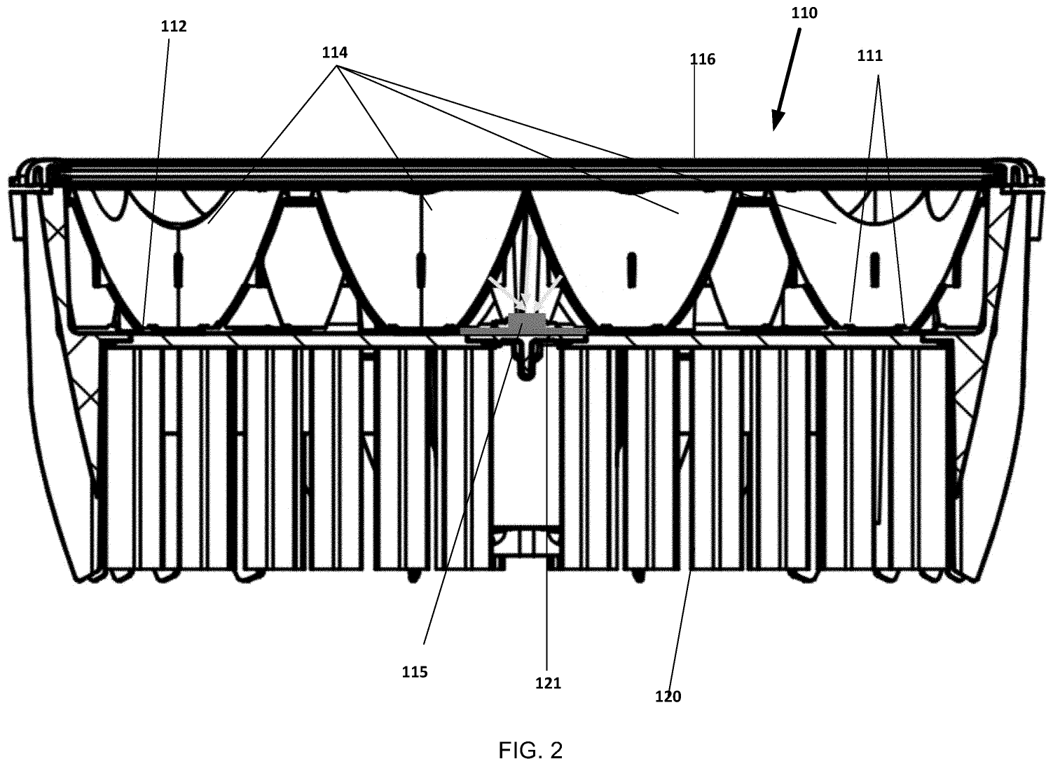

FIG. 2 illustrates a cross sectional view of a lighting module 110 of the lighting device 100. As shown in FIG. 2, each lighting module 110 includes a substrate 112 on which one or more LEDs 111 are positioned.

In certain embodiments, the substrate 112 may be a supporting structure configured to hold the LEDs 111 in place. For example, the substrate may be made of any support material (such as fiberglass, ceramic, silicon, or aluminum) with conductive elements (such as traces, bars or wires) placed thereon or therein to direct power, control signal, or the like to the LEDs 111. The conductive elements may be copper, silver or another conductive material and applied as conductive ink, wire, traces, or other materials to provide a conductive pathway. Optionally, the substrate 110 may include a portion that is a circuit board (not shown here). Driver circuitry on the circuit board and/or a controller (e.g., fixture controller) may deliver current, control signals, etc. to the LEDs 111 via one or more conductive elements on the substrate, such as conductive lines, traces, bars or wires positioned on the substrate. In certain embodiments, various conductors, electronic devices (e.g., sensors), etc. may also be mounted on the substrate. For example, a set of module-level conductors may be connected to the lighting module's power source and ground. Each module-level conductor may be connected to one of the conductive elements on the substrate.

The LEDs 111 may be arranged in one or more rows, matrices, or other arrangements with corresponding components supported in place and/or spaced apart by supports. For example, the LEDs may form matrices of n×n LEDs, such as 4×4 or 8×8 matrices. Alternatively, the LEDs in each module 110 may be positioned in curved rows so that when all modules are positioned within the opening, the LED structure comprises concentric rings of LEDs.

The lighting module 110 may also include an optical assembly 114 disposed over each of the LEDs that is configured to control the one or more optical properties (e.g., beam angle, stray light and color fringing) of the light emitted by the corresponding LED, and the whole lighting module 110. In certain embodiments, the optical assembly 114 may also protect the LEDs 111 from environmental elements such as, moisture, rain, dirt, excessive sunlight, or the like. Each optical assembly 114 may include one or more optical elements. Examples of such optical elements may include, without limitation, lenses, refractors, reflectors, lens covers, frosted beam optics, and/or the like. The optical elements of an optical assembly 114 may be made from a material, such as, for example and without limitation, plastic, resin, silicone, optical silicone, metal, metal coated plastic, acrylic, or the like. Furthermore, the optical assembly 114 may have many shapes, such as, for example, round, square, rectangular, diamond, or the like. A lighting module 110 may include identical optical assemblies 114. Alternatively, at least one of the optical assemblies 114 may be different.

In an example embodiment shown in FIG. 2, an LED 111 may be located under an optical assembly 114 comprising a collimating lens and a reflector. Optionally, a clear optical cover 116 may be placed on top of the optical assembly 114 to seal and protect the lens and the LEDs from environmental elements. It will be understood to those skilled in the art that the optical assembly 114 illustrated in FIG. 2 is provided as an example, and any other optical elements or their combination thereof may be included in the optical assembly 114 of the lighting module 110 without deviating from the principles of this disclosure. For example, the optical assembly 114 may include a combination of a reflector and a refractor configured to provide collimation or other properties of light received from the LEDs 111.

Each lighting module 110 may also include a temperature sensor 115 for monitoring the temperature of one or more optical assemblies 114. The temperature sensor 115 may be a contact temperature sensor (e.g., a thermocouple) and/or a non-contact type temperature sensor (e.g., an infrared (IR) temperature sensor). Optionally, a temperature sensor may also be configured to determine the temperature of other components inside the light module 110 such as, without limitation, the substrate (e.g., the dielectric temperature), wiring and/or traces, communication bus, LEDs, optical cover, etc. In this context, it should be also noted that an increase in temperature of the optical assembly or another component can also take place when the light module is not operating, for example if the optical assembly is exposed to external radiation, such as solar radiation.

In one or more embodiments, the temperature sensor 115 may be a non-contact temperature sensor, such as an infrared (IR) temperature sensor. Every component with a temperature above absolute zero emits IR radiation and/or reflects IR radiation, and a non-contact type IR temperature sensor has an infrared light sensor (probe) for sensing the intensity of such infrared radiation. The IR temperature sensor may convert the sensed intensity to a proportional signal that is indicative of temperature of the component (e.g., current or voltage) using a signal processing circuit (and/or send the intensity values to an external processing device for analysis). Such IR temperature sensors can receive infrared radiation from objects if they located within a predetermined area around the IR temperature sensor, i.e., the field of view. Typically, the sensor field of view is generally circular and the size of the sensor is such that it can be considered to be a point source/detector, and the diameter of the circular field of view increases with distance from the source to define a cone whose apex is at the center of the sensor. Example conical field of views for the IR temperature sensor of the current disclosure may be about 15° to about 75°, about 25° to about 65°, 35° to about 55°, 30° to about 60°, or the like. In certain embodiments, an IR temperature sensor may be positioned and/or its field of view may be configured such that only the components for which temperature needs to be monitored (e.g., optical assembly) are within the field of view of the temperature sensor and the temperature sensor only measures the temperature of such components.

It should be noted that the measured temperature value may be the average temperature of all components in the field of view of the IR temperature sensor. For determining the temperature of a specific component within the field of view of the temperature sensor: (i) the field of view may be adjusted such that only the specific component is within the field of view of the temperature sensor; (ii) the temperature sensor may be positioned such that only the specific component is within the field of view of the temperature sensor; and/or (iii) temperature data corresponding to components in the field of view other than the specific component may be eliminated from the overall temperature data collected by the temperature sensor. For example, temperature data collected by a separate LED specific temperature sensor may be taken into account if an LED is in the field of view of a temperature sensor that is required to collect temperature data of optical assembly only. Specifically, a second temperature sensor may collect temperature data corresponding to the LEDs which may be accounted for in determining the temperature of other components such as the optical assembly. In certain other embodiments, the IR sensor may also be shielded from light emitted by the LEDs to prevent the IR sensor from taking into consideration heat generated by the LEDs.

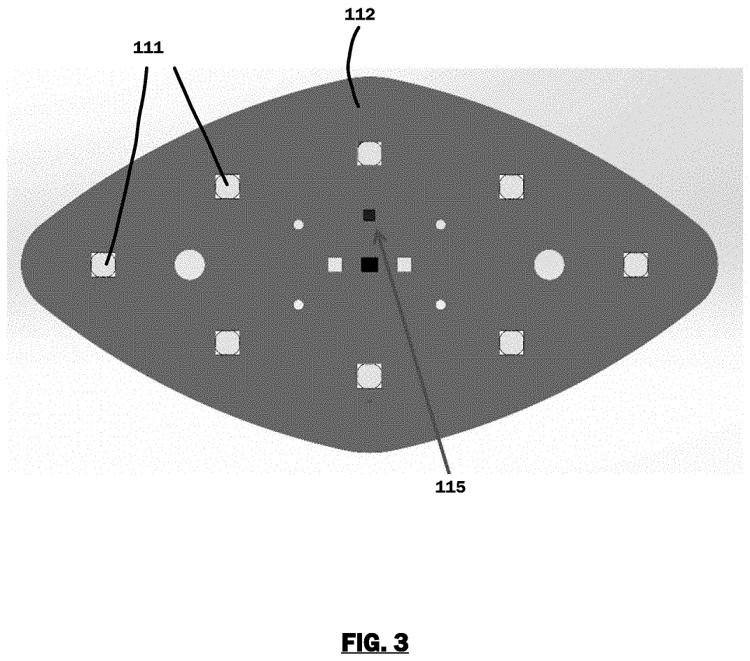

In certain embodiments, the temperature sensor 115 may be mounted in any suitable position on the substrate to enable determination of the temperature of one or more components of the lighting module 110. For a non-contact IR temperature sensor, the position may be determined based on the field of view of the IR temperature sensor and the position of the components to be monitored. For collecting temperature data corresponding to the optical assembly 114, a temperature sensor 115 may be mounted on the substrate 112 of a lighting module 110 (as shown in FIG. 2), such that the optical assembly 114 is within its field of view. For example, the temperature sensor 115 may be positioned near the center of the substrate 112 (as shown in FIG. 3) to enable it to monitor the temperature of one or more of the components (e.g. optical assembly) of the lighting module 110 that lie within the field of view of the IR temperature sensor. The position shown in FIG. 3 is provided by way of example only and may be changed based on, without limitation, the field of view of the IR temperature sensor, placement of one or more components inside the lighting module whose temperature is being monitored, or the like. Specifically, other positions are within the scope of this disclosure.

Optionally, a temperature sensor 115 mounted on the substrate 112 may also be positioned and/or configured to have a field of view for monitoring the temperature of one or more LEDs 111, the substrate 112, or other components inside the LED module 110. Additionally and/or alternatively, the temperature sensor 115 mounted on the substrate 112 may be configured to monitor the overall temperature inside the lighting module 110. When mounted on the substrate 112, the temperature sensor 115 may also be connected to the power source and/or the control circuit(s) (e.g., via traces or conductors) to provide power and/or data communication to the temperature sensor 115. In certain embodiments, the temperature sensor 115 may be mounted on the substrate 112 via a circuit card 121 that provides power, processing, and/or data communication to the temperature sensor 115.

While FIG. 2 illustrates one temperature sensor, it will be understood to those skilled in the art that any number of temperature sensors may be included in a lighting module 110. In certain embodiments, each temperature sensor may be configured and/or positioned to collect temperature data corresponding to one or more specific components of the lighting module. Optionally, a lighting module 110 may not include any temperature sensor, and temperature sensor located outside the lighting module (e.g., included in another lighting module, and/or in an area shared by the lighting modules of the lighting device 100) may be configured to monitor the temperature of one or more components of that lighting module. The temperature sensors 115 may likewise by spaced apart evenly or placed randomly in the lighting modules 110 of a lighting device 100.

In certain embodiments, the temperature sensor may have dimensions that allow for mounting of the temperature sensor on the substrate of a lighting module (e.g., approximately 1-5 mm² surface area and negligible thickness).

While the current disclosure describes the temperature sensor as being mounted on the substrate of the lighting module, the disclosure is not so limiting. For example, the temperature sensor may be mounted on a different supporting structure than the substrate for monitoring the temperature of other components (e.g., LEDs, substrate, etc.) of the lighting module.

The temperature sensor 115 may include a processor (not shown) configured to analyze the temperature data and provide information about the conditions or properties of the light module components such as the optical assembly 114. Alternatively and/or additionally, the processor may not be included in the temperature sensor 115 and an external processor (e.g., a processor of the lighting device 100, a circuit card, etc.) may receive data from the temperature sensor 115 via a communications link for analysis. The temperature sensor 115 may be connected to the power source and/or the control circuit(s) (e.g., via traces or conductors) of the lighting module 110 to provide power and/or data communication to the temperature sensor 115.

A temperature sensor 115 of the current disclosure may be used for continuous monitoring of the components (e.g., an optical assembly 114) of a lighting module 110, and may be configured to cause a processor to provide alerts, prompts, perform automatic restorative actions (e.g., cooling action), and/or instructions to prevent and/or reduce severity of damage to a lighting module 110 component due to overheating. For example, if it is determined that the temperature of a component such as an optical assembly is over a threshold, a prompt or an alert may be provided to a user to initiate a cooling action and/or turn off power supply to one or more LEDs of the lighting module. Alternatively and/or additionally, the power delivered to the LEDs may be controlled (e.g., switched off or reduced) automatically to prevent overheating of lighting module 110 component(s).

In one or more embodiments, the threshold may be determined based on one or more of the following: the type of LEDs, material of the components of the optical assembly, material of other components of the lighting module, ambient conditions (e.g., outside temperature, pressure, humidity, internal temperature, etc.), type of use of the lighting device (e.g., constant use v. occasional use), efficiency of the heat sink, alternate cooling mechanisms, or the like.

As discussed above, data collected by a temperature sensor 115 may be processed by a processor included in the temperature sensor 115, and/or may be transmitted to an external processor for analysis (e.g., fixture controller and/or module level controller of the lighting module 110). Optionally, the temperature sensor 115 may at least partially process the collected data and transmit such processed data to the external processor for further analysis and/or appropriate action. The external processor and the temperature sensor 115 may communicate with each other using any suitable communication protocol such as, without limitation, I2C. The controller may in turn control current delivered to the LEDs 113 of the lighting module 110 based on the received data. For example, the controller may throttle back power/current supplied to one or more LEDs 111 of the lighting module 110 if it is determined that the optical assembly 114 has a temperature that is greater than a threshold. Throttling back power to the LEDs will reduce thermal energy emitted by the LEDs and lead to a cooling effect inside the lighting module. The controller may throttle back power supplied to one or more LEDs 111 of the lighting module 110, for example, by decreasing or turning off current supplied to the LEDs 111, by decreasing pulse width modulation (PWM), or a combination thereof. In PWM, an oscillating output from the controller repeatedly turns the LEDs 111 on and off based by applying a pulsed voltage. Each pulse is of a constant voltage level, and the controller varies the width of each pulse and/or the space between each pulse. When a pulse is active, the LEDs 111 may be turned on, and when the pulses are inactive the LEDs 111 may be turned off. If the duty cycle of the “on” state is 50%, then the LEDs 111 may be on during 50% of the overall cycle of the control pulses. The controller may dim the LEDs 111 by reducing the duty cycle and effectively extending the time period between each “on” pulse, so that the LEDs are off more than they are on. Alternatively, the controller may decrease the brightness of the LEDs 111 by decreasing the duty cycle.

Typically, the maximum temperature that an optical assembly or another component of a lighting module can withstand before degradation is less than the maximum temperature the LEDs can withstand. For example, LEDs are typically designed to operate at temperatures as high as about 140° C. However, optical assembly components made of acrylic may start degrading at about 90° C. Similarly, lighting module component manufactured from polycarbonate (e.g., lens and/or reflector) may start warping or otherwise undergoing degradation at about 125° C. As such, a lighting device system that relies solely on temperature data and operating temperature limits of the LEDs to perform thermal management may breakdown or undergo degradation (before the LED threshold temperature is reached). Specifically, some action must be taken before the higher limit of the LED operating temperature is reached. For example, an action may include reducing the temperature by throttling power supplied to the LEDs when a threshold temperature is observed, where the threshold temperature is less than or equal to the upper limit of the operational temperature range of other components such as the optical assembly (and that is less than the operational temperature limit of the LEDs).

For monitoring and maintaining temperature of multiple components inside a light module and/or average temperature inside a light module, the threshold temperature may be a temperature that is less than or equal to the upper limit of the operational temperature range of the component that starts degrading at the lowest temperature amongst all such components. For example, if one component (e.g., reflector) is made of polycarbonate that has an upper limit of the operational temperature range of about 125° C., and another component is made of acrylic which has an upper limit of the operational temperature range of about 90° C. (e.g., lens cover), which are both less than the upper limit of the operational temperature range of LEDs (about 140° C.), the threshold temperature may be less than 90° C. (e.g., about 80-85° C.) to prevent degradation of any of the components inside the lighting module. Therefore, the processor may throttle back power supplied to one or more LEDs of the lighting module when the inside temperature and/or temperature of the component made from acrylic is determined to be about 80-85° C. Alternatively and/or additionally, the processor may first reduce the power supplied to one or more LEDs of the lighting module at a first threshold temperature (e.g., about 90° C. for an acrylic lens cover component), and may turn off the power completely at a second threshold temperature that is higher than the first threshold temperature (e.g., at about 100-110° C. for a polycarbonate optical assembly component).

In certain embodiments, the threshold temperature may be adjusted based the outside temperature. As another example, the threshold temperature may be lower in the presence of dirt or debris on the lighting module compared to when dirt or debris is not present in order to reduce overheating of the lighting module in a short period of time.

In certain embodiments, the processor may also monitor the temperature data to determine a rate of temperature change inside the lighting module. Rate of increase in the temperature of the lighting module that is more than a threshold may be indicative of problems with the lighting module such as, without limitation, an indication that the heat sink requires maintenance or cleaning, accumulation of dirt or debris on the optical assembly, a leak in the seal of the lighting device or module, breakage or other types of damage, or the like. The processor may create and output an alert for a user based upon such determination that includes information about the identified problems.

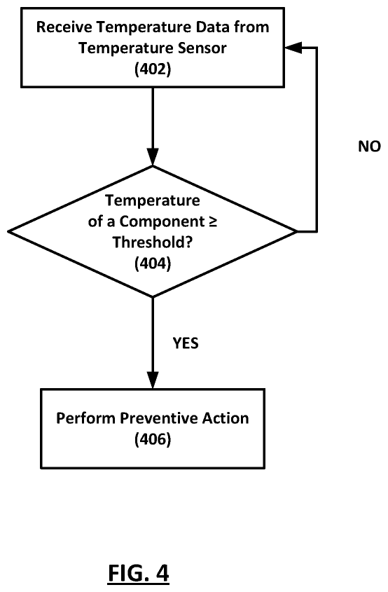

FIG. 4 illustrates an example flowchart in accordance with various embodiments illustrating and describing a method of monitoring the internal temperature of a lighting module and controlling power supplied to one or more LEDs of the lighting module of FIG. 1 based on the temperature data. While the method 400 is described for the sake of convenience and not with an intent of limiting the disclosure as comprising a series and/or a number of steps, it is to be understood that the process does not need to be performed as a series of steps and/or the steps do not need to be performed in the order shown and described with respect to FIG. 4 but the process may be integrated and/or one or more steps may be performed together, simultaneously, or the steps may be performed in the order disclosed or in an alternate order.

At 402, a processor may receive temperature data from one or more temperature sensor(s) included in a lighting module. The processor may analyze (404) the temperature data to determine if the inside temperature of the lighting module and/or temperature of one or more components (e.g., optical elements) of the lighting module is greater than or equal to a threshold temperature. The processor may determine the threshold temperature by accessing a rule set that includes threshold temperatures for various parameters such as ambient conditions, material of manufacture of a component, efficiency of heat sink, type of LEDs, use of LEDs, etc. (as discussed above).

If the inside temperature and/or temperature of one or more components of the lighting module is determined to be greater than or equal to the threshold temperature, the processor may (406) perform a preventive action (to prevent damage to one or more components of the lighting device due to overheating). For example, the controller may provide an alert to a user (e.g., via a mobile device or display) including information about the temperature and potential damage to the lighting device or its components. Optionally, the controller may also provide instructions to a user corresponding to potential corrective actions (e.g., clean the optical assembly if rate of temperature increase indicates obstruction, replace the optical assembly, turn off power, etc.). Alternatively and/or additionally, the controller may itself initiate such preventive action. For example, the controller may selectively throttle back power supplied to one or more LEDs of the lighting module. For example, the controller may throttle back power supplied to one or more LEDs of the lighting module by reducing current supplied to the LEDs or by reducing PWM. In certain embodiments, the controller may reduce the power supplied to one or more LEDs while maintaining a desired output of the lighting module (and/or lighting device) at a substantially constant level by, for example, turning on other LEDs and/or other lighting modules, increasing power to other LEDs, increasing PWM for other LEDs, or lighting modules of the lighting device.

As such, controlling the power supplied to the plurality of light sources dependent upon an internal temperature of the lighting module and/or temperature of a component (e.g., optical assembly) inside the lighting module can extend the useful life of the lighting module. For example, the useful life can be extended by limiting the possibility for heat related damage by preventing the temperature to rise above a threshold temperature sufficient to cause damage to the internal components and/or optical assembly of the lighting module.

FIG. 5 is a block diagram of hardware that may be including in any of the electronic devices described above, such as a lighting device or controller device. A bus 500 serves as an information highway interconnecting the other illustrated components of the hardware. The bus may be a physical connection between elements of the system, or a wired or wireless communication system via which various elements of the system share data. Processor 505 is a processing device of the system performing calculations and logic operations required to execute a program. Processor 505, alone or in conjunction with one or more of the other elements disclosed in FIG. 5, is an example of a processing device, computing device or processor as such terms are used within this disclosure. The processing device may be a physical processing device, a virtual device contained within another processing device, or a container included within a processing device. If the electronic device is a lighting device, processor 505 may be a component of a fixture controller, and the device would also include a power supply and optical radiation source as discussed above.

A memory device 510 is a hardware element or segment of a hardware element on which programming instructions, data, or both may be stored. An optional display interface 530 may permit information to be displayed on the display 535 in audio, visual, graphic or alphanumeric format. Communication with external devices, such as a printing device, may occur using various communication interfaces 550, such as a communication port, antenna, or near-field or short-range transceiver. A communication interface 550 may be communicatively connected to a communication network, such as the Internet or an intranet.

The hardware may also include a user input interface 555 which allows for receipt of data from input devices such as a keyboard or keypad 550, or other input device 555 such as a mouse, a touchpad, a touch screen, a remote control, a pointing device, a video input device and/or a microphone. Data also may be received from an image capturing device 520 such as a digital camera or video camera. A positional sensor 560 and/or motion sensor 570 may be included to detect position and movement of the device. Examples of motion sensors 570 include gyroscopes or accelerometers. Examples of positional sensors 560 such as a global positioning system (GPS) sensor device that receives positional data from an external GPS network.

The features and functions described above, as well as alternatives, may be combined into many other systems or applications. Various presently unforeseen or unanticipated alternatives, modifications, variations or improvements may be made by those skilled in the art, each of which is also intended to be encompassed by the disclosed embodiments.

1. A lighting module for an illumination device, the lighting module comprising:
at least one light source mounted on a substrate;
an optical assembly positioned to be located over the at least one light source;
a temperature sensor configured to collect temperature data corresponding to the optical assembly.

2. The lighting module of claim 1, wherein the temperature sensor is an infrared (IR) sensor.

3. The lighting module of claim 1, further comprising:
a processor; and
a non-transitory computer-readable medium comprising programming instructions that when executed by the processor, cause the processor to:
receive, from the temperature sensor, temperature data corresponding to the optical assembly;
analyze the received temperature data to determine if temperature of the optical assembly is greater than a threshold temperature; and
in response to determining that the temperature of the optical assembly is greater than a threshold temperature, perform a preventive action.

4. The lighting module of claim 3, wherein the preventive action comprises providing an alert to a user, the alert comprising at least one of the following:
instructions to initiate a cooling action;
instructions to control power delivered to the at least one light source; or
information relating to potential damage to one or more components of the lighting module due to overheating.

5. The lighting module of claim 3, wherein the preventive action comprises controlling power delivered to the at least one light source.

6. The lighting module of claim 5, wherein the programming instructions to control the power delivered to the at least one light source comprise instructions to reduce power delivered to the at least one light source while maintaining a constant illumination output by the lighting module.

7. The lighting module of claim 3, wherein further comprising programming instructions configured to cause the processor to:
analyze the received information to determine a rate of change of temperature of the optical assembly;
analyze the rate of change of temperature to determine whether the lighting module includes a fault condition; and
provide an alert to a user, wherein the alert includes information about the fault condition.

8. The lighting module of claim 7, wherein the fault condition comprises accumulation of debris on the optical assembly that leads to overheating of the optical assembly.

9. The lighting module of claim 3, wherein the threshold level is determined based on at least one of the following: a type of the at least one light source, a material of the optical assembly, a material of other components of the lighting module, one or more ambient conditions, a type of use of the lighting module, or efficiency of a heat sink associated with the lighting module.

10. The lighting module of claim 3, wherein the threshold level is less than a first upper limit associated with an operational temperature range of the optical assembly, the first upper limit being less than a second upper limit associated with an operational temperature range of the at least one light source.

11. The lighting module of claim 1, wherein the temperature sensor is mounted on the substrate.

12. A temperature sensor for sensing real-time temperature of an optical assembly of a lighting device comprising at least one light source situated under the optical assembly, the temperature sensor comprising an infrared (IR) sensor having a field of view that includes the optical assembly when the temperature sensor is included inside the lighting device.

13. The temperature sensor of claim 12, further comprising a processor configured to:
analyze blackbody radiation emitted by the optical assembly to determine a temperature of the optical assembly;
analyze the temperature data to determine if temperature of the optical assembly is greater than a threshold temperature; and
in response to determining that the temperature of the optical assembly is greater than a threshold temperature, perform a preventive action.

14. The temperature sensor of claim 13, wherein the preventive action comprises providing an alert to a user, the alert comprising at least one of the following:
instructions to initiate a cooling action;
instructions to control power delivered to the at least one light source; or
information relating to potential damage to one or more components of the lighting device due to overheating.

15. The temperature sensor of claim 13, wherein the preventive action comprises controlling power delivered to the at least one light source.

16. The temperature sensor of claim 15, wherein the processor is configured to control the power delivered to the at least one light source by reducing power delivered to the at least one light source while maintaining a constant illumination output by the lighting device.

17. The temperature sensor of claim 13, wherein the processor is further configured to:
analyze the received information to determine a rate of change of temperature of the optical assembly;
analyze the rate of change of temperature to determine whether the lighting module includes a fault condition; and
provide an alert to a user, wherein the alert includes information about the fault condition.

18. The temperature sensor of claim 17, wherein the fault condition comprises accumulation of debris on the optical assembly that leads to overheating of the optical assembly.

19. The temperature sensor of claim 13, wherein the threshold level is determined based on at least one of the following: a type of the at least one light source, a material of the optical assembly, a material of other components of the lighting module, one or more ambient conditions, a type of use of the lighting module, or efficiency of a heat sink associated with the lighting module.

20. The temperature sensor of claim 13, wherein the threshold level is less than a first upper limit associated with an operational temperature range of the optical assembly, the first upper limit being less than a second upper limit associated with an operational temperature range of the at least one light source.
